(19) United States
(12) Patent Application Publication
(10) Pub. No.: US 2014/0169728 A1
(43) Pub. Date: Jun. 19, 2014

(54) WAVEGUIDE LENS INCLUDING PLANAR WAVEGUIDE AND MEDIA GRATING

(71) Applicant: HON HAI PRECISION INDUSTRY CO., LTD., New Taipei (TW)

(72) Inventor: HSIN-SHUN HUANG, New Taipei (TW)

(73) Assignee: HON HAI PRECISION INDUSTRY CO., LTD., New Taipei (TW)

(21) Appl. No.: 13/736,948

(22) Filed: Jan. 9, 2013

(30) Foreign Application Priority Data
Dec. 17, 2012 (TW) 101147898

(51) Int. Cl. G02B 6/12

(52) U.S. Cl. CPC G02B 6/12
USPC 385/14

(57) ABSTRACT

A waveguide lens includes a substrate, a planar waveguide, a media grating, and a pair of electrodes. The planar waveguide is formed on the substrate and is coupled with a laser light source which emits a laser beam having a divergent angle into the planar waveguide. The media grating is formed on the planar waveguide and arranged along a direction that is substantially parallel with an optical axis of the laser beam. The electrodes are positioned on the planar waveguide and arranged at opposite sides of the media grating and flanking the optical axis. The electrodes change an effective refractive index of the planar waveguide, utilizing an electro-optical effect, when an electric field is applied thereto.

### BACKGROUND

1. Technical Field

The present disclosure relates to integrated optics and, particularly, to a waveguide lens.

2. Description of Related Art

Lasers are used as light sources in integrated optics as the lasers have excellent directionality, as compared to conventional light sources. However, laser beams emitted by the lasers still have a divergence angle. As such, if the laser is directly connected to an optical element, some divergent rays may not be able to enter into the optical element, decreasing light usage.

Therefore, it is desirable to provide a waveguide lens, which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric schematic view of a waveguide lens, according to an embodiment.

FIG. 2 is a cross-sectional view taken along a line II-II of FIG. 1.

FIG. 3 is a schematic view of a media grating of the waveguide lens of FIG. 1.

### DETAILED DESCRIPTION

Embodiments of the present disclosure will be described with reference to the drawings.

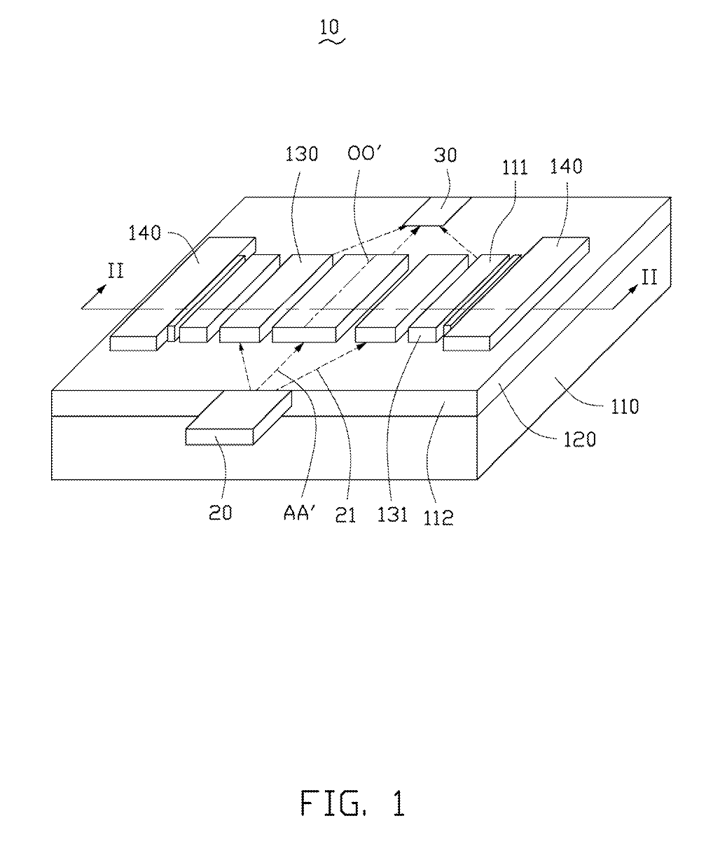

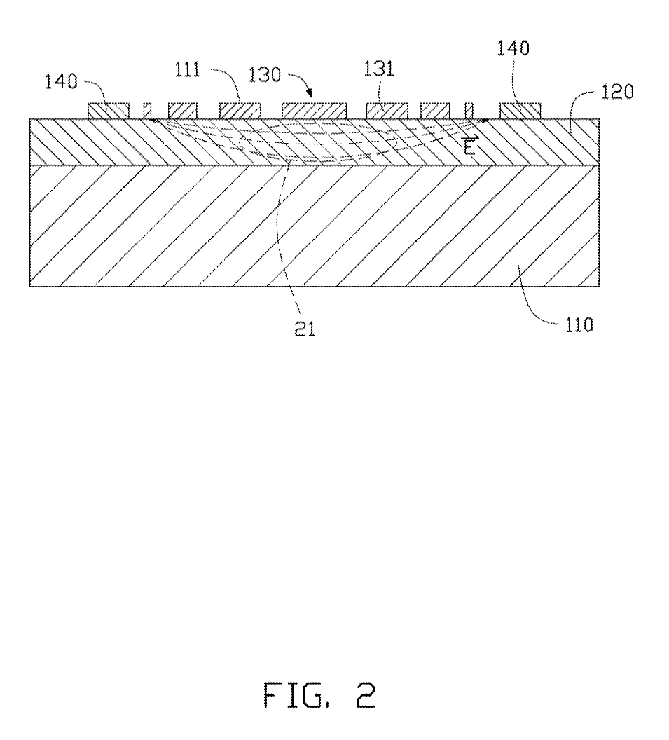

Referring to FIGS. 1-2, a waveguide lens 10, according to an embodiment, includes a substrate 110, a planar waveguide 120 formed on the substrate 110, a media grating 130 formed on the planar waveguide 120, and a pair of electrodes 140. The planar waveguide 120 is coupled with a laser light source 20 which emits a laser beam 21 having a divergent angle into the planar waveguide 120. The media grating 130 is arranged along a direction that is substantially parallel with an optical axis AA′ of the laser beam 21. The media grating 130 and the planar waveguide 120 constitute a diffractive waveguide lens to converge the laser beam 21 into an optical element 30. The electrodes 140 are arranged at opposite sides of the media grating 130 and the line of the midpoint between the electrodes 140 is followed by the optical axis AA′. The electrodes 140 change an effective refractive index of the planar waveguide 120 to change an effective focal length of the diffractive waveguide lens, utilizing an electro-optical effect, when a modulating electric field E is applied thereto.

In detail, the media grating 130 includes a number of media strips 131. Each media strip 131 and the planar waveguide 120 cooperatively form a strip-loaded waveguide. An effective refractive index of portions of the planar waveguide 120 where each media strip 131 is located (i.e., a portion of the planar waveguide 120 beneath each media strip 131) is increased. As such, by properly constructing the media grating 130, for example, constructing the media grating 130 as a chirped grating, the media grating 130 and the planar waveguide 120 can function as, e.g., a chirped diffractive waveguide lens.

By virtue of the electrodes 140 and the accompanying modulating electric field E , the effective focal length of the diffractive waveguide lens can be adjusted as desired to ensure the effective convergence of the laser beam 21 into an optical element 30 at any distance from the laser light source 20.

The substrate 110 is substantially rectangular and includes a top surface 111 and a side surface 112. In this embodiment, the substrate 110 is made of lithium niobate (LiNbO₃) crystal.

The planar waveguide 120 is formed by coating a film of titanium (Ti) on the top surface 111 and then diffusing the Ti into the top surface 111 by a high temperature diffusion technology. That is, the planar waveguide 120 is made of LiNbO₃ diffused with Ti (Ti: LiNbO₃), of which the effective refractive index gradually changes along the widthwise direction thereof, benefitting the creating of the diffractive waveguide lens. After the planar waveguide 120 is formed, the top surface 111 becomes an upper surface of the planar waveguide 120.

The media grating 130, such as a chirped grating, is formed by etching the upper surface of the planar waveguide 120 (i.e., the top surface 111). That is, the media grating 130 is also made of Ti:LiNbO₃. After the media grating is formed, the top surface 111 is an upper surface of the media grating 130. There are an odd number of the media strips 131. The media strips 131 are symmetrical about a widthwise central axis OO′ of the media grating 130. Each of the media strips 131 are parallel and rectangular. In order from the widthwise central axis OO′ outwards to each side, widths of the media strips 131 decrease, and widths of gaps between each two adjacent media strips 131 also decrease.

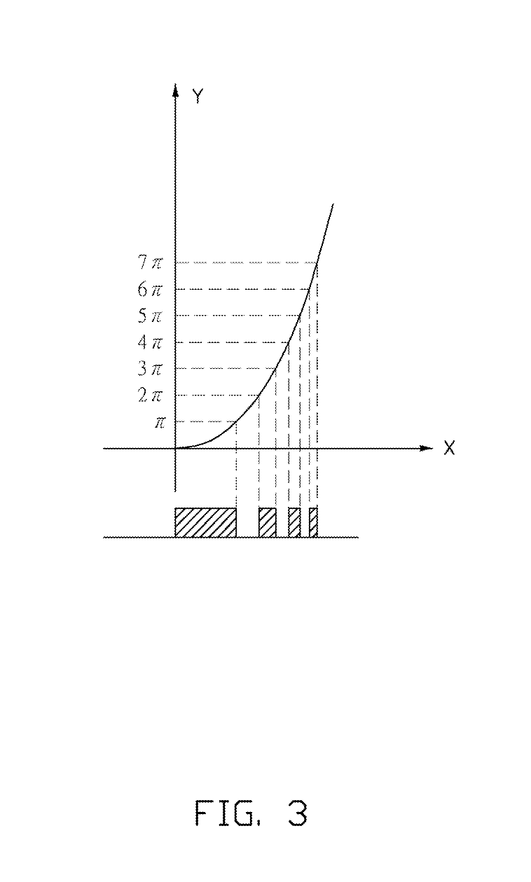

Referring to FIG. 3, a coordinate system “oxy” is established, wherein the origin “o” is an intersecting point of the widthwise central axis OO′ and a widthwise direction of the planar waveguide 120, “x” axis is the widthwise direction of the planar waveguide 120, and “y” axis is a phase shift of the laser beam 21 at a point “x”. According to wave theory of planar waveguides, y=α(1−e^{kx}^{²}), wherein x>0, α, e, and k are constants. In this embodiment, boundaries of the media strips 131 are set to conform with the conditions of the formulae: yₙ=α(1−e^{kx}^{ₙ}^{²}) and yₙ=nπ, wherein xₙ is the nth boundary of the media strips 131 along the “x” axis, and yₙ is the corresponding phase shift. That is,

$${x}_{n} = \sqrt{\frac{ln ( 1 - \frac{n π}{a} )}{k}} ( {x}_{n} > 0 ) .$$

The boundaries of the media strips 131 where xₙ<0 can be determined by the characteristics of symmetry of the media grating 130.

The electrodes 140 are symmetrical about the central axis OO′ and aligned with the media grating 130 so as to be parallel to the media strips 131. A length of each of the electrodes 140 is longer or equal to a length of the media grating 130, and height of each of the electrodes 140 is greater than or equal to a height of the media grating 130. As such, the modulating electric field E can effectively modulate the light beam 21 to change the effective refractive index of the planar waveguide 120.

The laser light source 20 can be a distributed feedback laser, and is attached to a portion of the side surface 112 corresponding to the planar waveguide 120. The optical axis AA′ is aligned with the widthwise central axis OO′.

The optical element 30 can be a strip waveguide, an optical fiber, or a splitter.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the possible scope of the disclosure but do not restrict the scope of the disclosure.

What is claimed is:

1. A waveguide lens, comprising:
a substrate;
a planar waveguide formed on the substrate and used for coupling with a laser light source which emits a laser beam having a divergent angle into the planar waveguide;
a media grating formed on the planar waveguide and arranged along a direction that is substantially parallel with an optical axis of the laser beam;
a pair of electrodes positioned on the planar waveguide and arranged at two opposite sides of the media grating and the optical axis, the electrodes being configured to change an effective refractive index of the planar waveguide, utilizing electro-optical effect, when a modulating electric filed is applied thereto.

2. The waveguide lens of claim 1, wherein the substrate is made of lithium niobate crystal.

3. The waveguide lens of claim 1, wherein the planar waveguide is made of lithium niobate crystal diffused with titanium.

4. The waveguide lens of claim 1, wherein the media grating is made of lithium niobate crystal diffused with titanium.

5. The waveguide lens of claim 1, wherein the substrate is substantially rectangular and comprises a top surface and a side surface perpendicularly connecting the top surface, the planar waveguide and the media grating are formed in the top surface, and the laser light source is attached to a portion of the planar waveguide corresponding to the planar waveguide.

6. The waveguide lens of claim 1, wherein the media grating is a chirped grating.

7. The waveguide lens of claim 1, wherein the media grating comprises a plurality of media strips, the number of the media strips is odd, the media strips are symmetrical about a widthwise central axis of the media grating, each of the media strips is rectangular and parallel with each other, in this order from the widthwise central axis to each widthwise side of the media grating, widths of the media strips decrease, and widths of gaps between each two adjacent media strips also decrease.

8. The waveguide lens of claim 7, wherein a coordinate axis “ox” is established, wherein the origin “o” is an intersecting point of the widthwise central axis and a widthwise direction of the planar waveguide, and “x” axis is the widthwise direction of the planar waveguide, boundaries of the media strips are set to conform condition formulae:
$${x}_{n} = \sqrt{\frac{ln ( 1 - \frac{n π}{a} )}{k}} ,$$
and ^{x}ₙ>0, wherein xₙ is the nth boundary of the media strips along the “x” axis, and α, e, and k are constants.

9. The waveguide lens of claim 1, wherein a length of each of the electrodes is longer or equal to a length of the media grating, and a height of each of the electrodes is greater or equal to a height of the media grating.
